(19) United States
(12) Patent Application Publication
(10) Pub. No.: US 2003/0156370 A1
(43) Pub. Date: Aug. 21, 2003

(54) Power distribution panel capable of transmitting data and wired telecommunication network system including the same

(75) Inventor: Kenichi Yokoo, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/370,331

(22) Filed: Feb. 19, 2003

(30) Foreign Application Priority Data
Feb. 20, 2002 (JP) 2002-043107

(51) Int. Cl. H02H 3/00

(52) U.S. Cl. 361/62

(57) ABSTRACT

A power distribution panel includes circuit breakers for a commercial power supply and filters for transmitting high-frequency signals between the upstream line and the downstream line of the individual circuit breaker and cutting off the frequency of signals sent from the commercial power supply.

### BACKGROUND OF THE INVENTION

1. Field of the Invention

The present invention relates to a power distribution panel for a commercial power supply and a wired telecommunication network system including the power distribution panel.

2. Description of the Related Art

A wired telecommunication network system using power wiring for a commercial power supply is known. This system supplies power to information processors, such as a personal computer (PC), through in-house wiring lines. The wired telecommunication network system incorporates a power line communication modem in each of the information processors and communicates data through the in-house wiring lines via the power line communication modems to perform data transmission among the information processors installed in the same in-house area or to exchange data with other information processors installed in other in-house areas. When the information processors run on batteries like a laptop PC, no power supply through the in-house wiring lines is needed; in such a case, only the power line communication modem is connected to the in-house wiring lines.

FIG. 3 is a diagram showing the structure of the known wired telecommunication network system described above. A power distribution panel 10 is installed in an in-house area and ordinarily has a primary circuit breaker 10a and a plurality of secondary circuit breakers 10b branching off the primary circuit breaker 10a. Power is supplied to the primary circuit breaker 10a through a lead-in wire 11. Power is supplied to information processors 12 through in-house wiring lines 13 downstream of the secondary circuit breakers 10b. A power line communication modem 12a in the individual information processor 12 is RF-connected to the corresponding in-house wiring line 13. An outlet (not shown) is provided between each of the information processors 12 and the corresponding in-house wiring line 13.

In the above structure, the information processors 12 in the same in-house area exchange data with each other through the secondary circuit breakers 10b and the information processors 12 exchange data with other information processors installed in other in-house areas or the like through the primary circuit breaker 10a and the secondary circuit breakers 10b.

However, when the secondary circuit breakers are operating, the in-house wiring lines downstream of the secondary circuit breakers are disconnected from each other, so that data transmission among the information processors in the in-house area is disabled even when laptop PCs driven by batteries are used as the information processors.

When the primary circuit breaker is operating, the lead-in wire is disconnected from the in-house wiring lines, so that data transmission between the information processors in the in-house area and those in other in-house areas is disabled.

### SUMMARY OF THE INVENTION

Accordingly, it is an object of the present invention to provide a power distribution panel that enables data transmission between the upstream sides and the downstream sides of circuit breakers even when the circuit breakers are operating. It is another object of the present invention to build a wired telecommunication network system including the above power distribution panel.

The present invention provides, in its first aspect, a power distribution panel including circuit breakers for a commercial power supply and filters for transmitting high-frequency signals between the upstream line and the downstream line of the individual circuit breaker and cutting off the frequency of signals sent from the commercial power supply. With such a power distribution panel, the high-frequency signals can be transmitted between the upstream side and the downstream side through the lines even when the circuit breakers are operating.

In the power distribution panel, the filters preferably are high-pass filters. The filters for transmitting the high-frequency signals and cutting off the frequency of signals sent from the commercial power supply can be easily realized in this case.

The circuit breakers preferably are a primary circuit breaker and a plurality of secondary circuit breakers branching off the primary circuit breaker. With this structure, data transmission not only among information processors in the same in-house area but also among information processors in different in-house areas can be achieved through the lines.

Each of the upstream line and the downstream line preferably has a pair of lines. The individual circuit breaker preferably has a pair of switches corresponding to the pair of lines. Each of the high-pass filters preferably has an input terminal, an output terminal DC-insulated from the input terminal, and ground terminals, wherein the input terminal is connected to one line of the pair of upstream lines, the output terminal is connected to one line of the pair of downstream lines, and one ground terminal is connected to the other line of the pair of upstream lines and the other ground terminal is connected to the other line of the pair of downstream lines through a DC cut-off capacitor. With such a structure, data can be transmitted using the pair of lines as transmission lines and the upstream side of the individual circuit breaker can be DC-insulated from the downstream side thereof when the circuit breakers are operating.

The present invention provides, in its second aspect, a wired telecommunication network system including the power distribution panel, information processors provided downstream of the secondary circuit breakers, and power line communication modems. Power is supplied to the information processors. The data input/output terminal of the individual information processor is connected to the downstream line of the corresponding secondary circuit breaker through each of the power line communication modems. Such a system can be easily realized.

The power line communication modem is preferably included in the individual information processor. With such a structure, the data transmission using the lines as the transmission lines can be realized only by supplying power to the information processor from the commercial power supply.

The above and other objects, features, and advantages of the present invention will become clear from the following description of the preferred embodiments taken in conjunction with the accompanying drawings.

### BRIEF DESCRIPTION OF THE DRAWINGS

FIG. 1 is a block diagram showing the structure of a power distribution panel and a wired telecommunication network system including the power distribution panel according to an embodiment of the present invention;

FIG. 2 is a circuit diagram of a high-pass filter and a circuit breaker included in the power distribution panel of the present invention; and

FIG. 3 is a block diagram showing the structure of a known power distribution panel and a known wired telecommunication network system including the power distribution panel.

### DESCRIPTION OF THE PREFERRED EMBODIMENTS

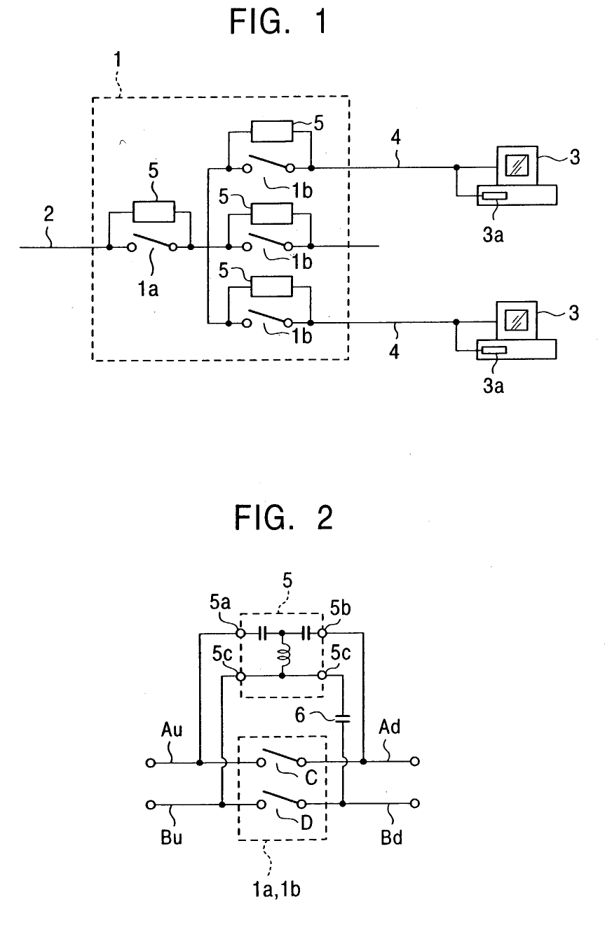

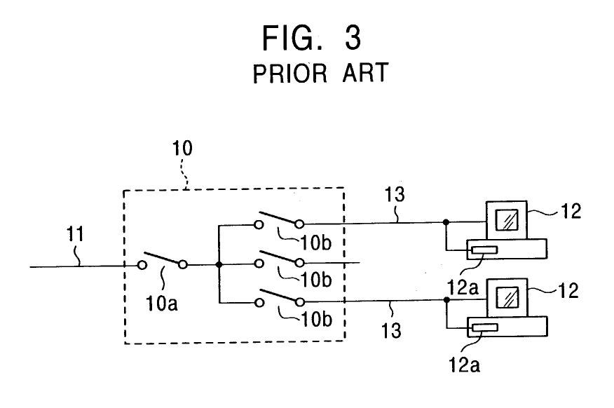

FIG. 1 is a block diagram showing the structure of a power distribution panel and a wired telecommunication network system including the power distribution panel according to an embodiment of the present invention. FIG. 2 is a circuit diagram of a high-pass filter and a circuit breaker included in the power distribution panel of the present invention.

Referring to FIG. 1, a power distribution panel 1 ordinarily has a primary circuit breaker 1a and a plurality of secondary circuit breakers lb branching off the primary circuit breaker 1a. Power is supplied to the primary circuit breaker 1a through a lead-in wire 2. Power is supplied to information processors 3 through in-house wiring lines 4 downstream of the secondary circuit breakers 1b. Although each information processor 3 typically is a PC (a desktop PC or a portable laptop PC), it may be a variety of office automation equipment, an instrument, a CCD camera, or the like. The individual information processor 3 is provided with a power line communication modem (PLC) 3a. The power line communication modem 3a of the information processor 3 is RF-connected to the corresponding in-house wiring line 4. An outlet (not shown) is provided between each of the information processors 3 and the corresponding in-house wiring line 4.

The data input/output terminal of each of the information processors 3 is connected to the data input/output terminal of the corresponding power line communication modem 3a.

The power line communication modem 3a is not necessarily included in the information processor 3 and may be provided outside the information processor 3.

A high-pass filter 5 is connected between the upstream line and the downstream line of the primary circuit breaker 1a, and a high-pass filter 5 is connected between the upstream line and the downstream line of each of the secondary circuit breakers 1b. The high-pass filter 5 has a frequency characteristic (cut-off frequency characteristic) that transmits data output from the power line communication modem 3a. The input and the output of the high-pass filter must be DC-insulated.

FIG. 2 is an exemplary connection between the primary circuit breaker 1a or one of the secondary circuit breakers 1b and the high-pass filter 5. The lead-in wire 2 has a pair of lines and each of the in-house wiring lines 4 also has a pair of lines. Accordingly, the circuit breaker 1a or each of the secondary circuit breakers 1b has two mechanical switches C and D corresponding to the respective lines. The high-pass filter 5 may be one segment of a simple constant K filter (T type filter) and the input terminal 5a of the high-pass filter 5 is DC-insulated from the output terminal 5b thereof. The input terminal 5a is connected to an upstream line Au of one line and the output terminal 5b is connected to a downstream line Ad of the line. One ground terminal 5c is connected to an upstream line Bu of the other line and the other ground terminal 5c is connected to a downstream line Bd of the other line through a DC cut-off capacitor 6.

With such a structure described above, data can be transmitted using one line as an RF-ground line and using the other line as a transmission line. The DC cut-off capacitor DC-insulates the upstream side from the downstream side when the primary circuit breaker 1a or one of the secondary circuit breakers 1b is operating.

What is claimed is:

1. A power distribution panel comprising:
circuit breakers for a commercial power supply; and
filters for transmitting high-frequency signals between an upstream line and a downstream line of the individual circuit breaker and cutting off the frequency of signals sent from the commercial power supply.

2. A power distribution panel according to claim 1, wherein the filters are high-pass filters.

3. A power distribution panel according to claim 1, wherein the circuit breakers are a primary circuit breaker and a plurality of secondary circuit breakers branching off the primary circuit breaker.

4. A power distribution panel according to claim 1, each of the upstream line and the downstream line including a pair of lines, the individual circuit breaker including a pair of switches corresponding to the pair of lines, each of the high-pass filters including an input terminal, an output terminal DC-insulated from the input terminal, and ground terminals, wherein the input terminal is connected to one line of the pair of upstream lines, the output terminal is connected to one line of the pair of downstream lines, and one ground terminal is connected to the other line of the pair of upstream lines and the other ground terminal is connected to the other line of the pair of downstream lines through a DC cut-off capacitor.

5. A wired telecommunication network system comprising:
the power distribution panel according to claim 3;
information processors provided downstream of the secondary circuit breakers, power being supplied to the information processors; and
power line communication modems through each of which a data input/output terminal of the individual information processor is connected to a downstream line of the corresponding secondary circuit breaker.

6. A wired telecommunication network system according to claim 5, wherein each of the power line communication modems is included in the individual information processor.
